(19) United States
(12) Patent Application Publication
(10) Pub. No.: US 2014/0370484 A1
(43) Pub. Date: Dec. 18, 2014

(54) APPARATUS AND METHOD FOR MEASURING SCHOOL CLIMATE

(71) Applicant: edMosphere LLC, Austin, TX (US)

(72) Inventor: Lorna Mae N. Hermosura, Austin, TX (US)

(21) Appl. No.: 14/304,498

(22) Filed: Jun. 13, 2014

Related U.S. Application Data
(60) Provisional application No. 61/835,160, filed on Jun. 14, 2013.

(51) Int. Cl. G09B 7/07

(52) U.S. Cl. CPC G09B 7/07
USPC 434/350

(57) ABSTRACT

Provided is a process for surveying students to assess school climate and, based on survey answers, providing a real-time dashboard showing school climate to teachers, such that a troubled student's problems can be addressed before the troubled student's education is impaired.

### CROSS-REFERENCE TO RELATED APPLICATIONS

The present application claims the benefit of U.S. Provisional Patent Application 61/835,160, filed 14 Jun. 2013, titled Method for quantifying school climate and using that data to manage school climate, the contents of which are incorporated by reference in their entirety for all purposes.

### BACKGROUND

1. Field

The present invention relates generally to distributed educational computer applications and, more specifically, to systems and methods for measuring school climate.

2. Description of the Related Art

School climate refers to the quality and character of school life as perceived by students. Examples of issues affecting school climate include whether students feel safe, are well fed, and are well rested. Generally, school climate is affected by the following four factors: safety, relationships, teaching and learning, and external factors (e.g., home-life). School climate can refer to either an aggregate of what a group of students are experiencing (e.g., an average number of students reporting feeling bullied) or to an individual student's experiences (e.g., a specific instance in which a given student was bullied).

School climate matters. Studies have shown that a positive school climate is associated with increased student achievement, increased student engagement, increased teacher retention, decreased student dropouts and decreased school violence. In other words, when students feel that their school is safe and supportive, they perform better academically, they pay attention in class, and they help contribute to a safe school.

However, school climate is difficult to measure adequately with conventional techniques. Some schools administer yearly or quarterly surveys in which students report their experiences related to school climate. These in-frequent surveys generally fail to capture more transient student experiences that, if occurring with sufficient frequency, or if of sufficient gravity, can seriously impair a child's education. Indeed, many issues students face are best addressed with prompt teacher action, before a student falls behind in school. Yet many existing solutions take days for student surveys to be processed and for results returned to teachers.

Further, these conventionally-administered surveys generally impose a high cognitive burden on students and school faculty, e.g., teachers and administrators. Even quarterly surveys consume valuable class time and student attention during survey administration, particularly for elementary school students having a relatively small attention budget, and faculty often lack time or financial resources to analyze and digest survey results.

Thus, simply repeating existing techniques more often to capture transient disturbances in school climate is not an adequate solution because those techniques are much too slow and too burdensome on teachers and students.

### SUMMARY

The following is a non-exhaustive listing of some aspects of the present techniques. These and other aspects are described in the following disclosure.

Some aspects include a process for surveying students to assess school climate and, based on survey answers, providing a real-time dashboard showing school climate to teachers, such that a troubled student's problems can be addressed before the troubled student's education is impaired.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements.

FIG. 1A is a block diagram of an embodiment of a system for monitoring school climate in accordance with some aspects of the present inventions.

FIG. 1B is a flow chart that illustrates the interaction between an embodiment of the present invention, a student user, a teacher user, and an administrator user.

FIG. 2 is a screen shot of an interface to present the first ten of questions to the student in an example survey, which may be administered by the system of FIG. 1A over the Internet and displayed in a web browser of a student device.

FIG. 3 is a screen shot of the last interface (e.g., an interactive web page) of the example survey, showing an example of a text input by which (in this example) students have the option of sending a message directly to the school counselor or administrator rather than submitting the message to their teacher.

FIG. 4 is a screen shot of an example of a teacher dashboard interface, which in this example, presents aggregated student answers to the example survey, organized by period.

FIG. 5 is a screen shot of an example of a school (e.g., campus) dashboard interface, which may contain aggregated student answers to the example survey, organized by teacher.

FIG. 6 is a screen shot of an example of a district dashboard interface, which may present aggregated student answers to the example survey, organized by school campus.

FIG. 7 is an example of a computer system by which the present techniques may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

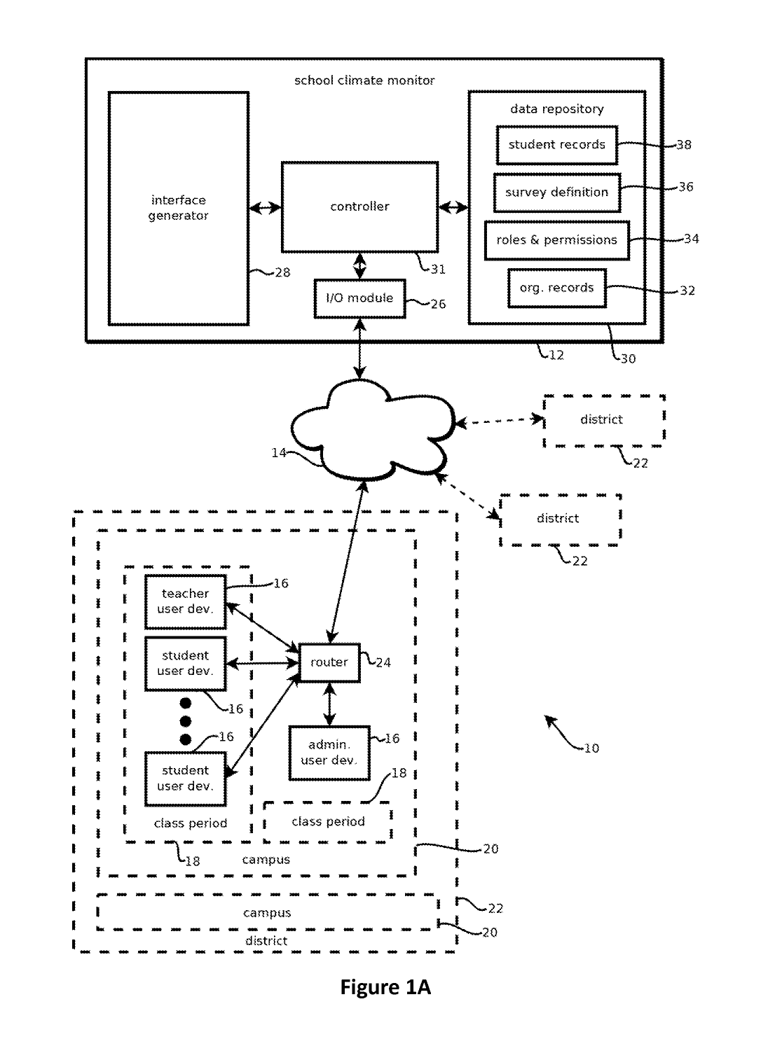

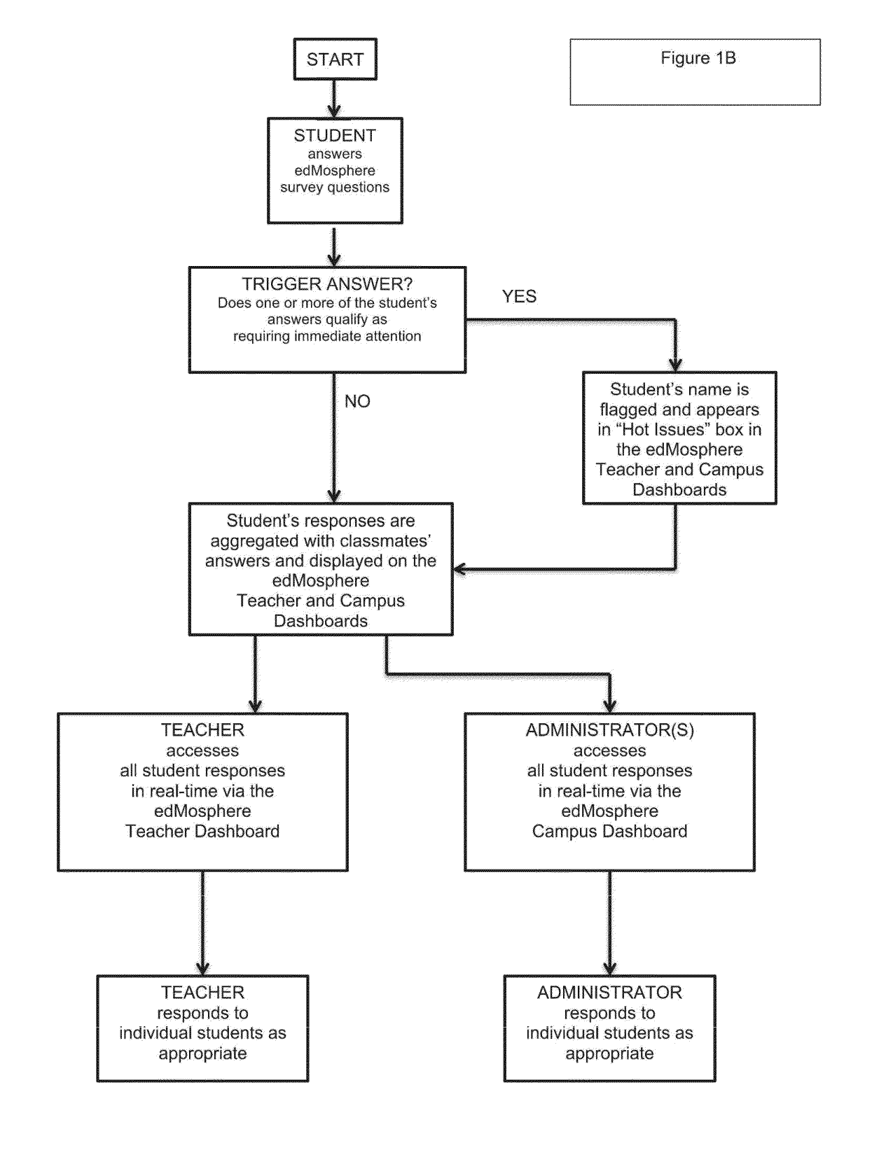

To mitigate the problems described herein, the applicants had to both invent solutions and, in some cases just as importantly, recognize problems overlooked (or not yet foreseen) by others in the field. Indeed, applicants wish to emphasize the difficulty of recognizing those problems that are nascent and will become much more apparent in the future should trends in education continue as applicants expect. Further, because multiple problems are addressed, it should be understood that some embodiments are problem-specific, and not all embodiments address every problem with traditional systems described herein or provide every benefit described herein. That said, solutions to many of these problems are described with reference to FIGS. 1-7.

FIG. 1A shows an example of a computing environment 12 configured to provide the functionality described herein. In some embodiments, the computing environment 12 includes a school climate monitor 12 configured to communicate over the Internet 14 (or a private network, for on-premises installations) with a plurality of user devices 16, upon which the following may occur: surveys are presented to students, students select answers to survey questions, those answers are sent to the school climate monitor 12, and teachers and administrators view the results of the surveys, e.g., with various supported dashboard interfaces. Sessions with the user devices 16 (and in some cases the devices themselves) may be organized (e.g., in records in the school climate monitor 12) in a hierarchy corresponding to the organizational structure of schools, so that survey responses, roles, and dashboards may be organized along those lines, e.g., grouping results by class period 18, teacher (mapped to one or more class periods 18), campus 20, and school district 22. In the figure, relatively few of items 16, 18, 20, 22, and 24 are shown, but it should be appreciated that commercial embodiments will likely have substantially more instances of each, e.g., on the order of hundreds of districts, thousands of campuses, tens of thousands of schools, and millions of students, or more.

Scale and low-latency are expected to be important to commercially feasible implementations of some embodiments, as many school districts are cost sensitive, and students tend to be particularly demanding users of distributed applications—some studies have found user engagement appreciably decreases with as much as 400 milliseconds latency increase. To accommodate the expected scale of users, and the expected bursts of user activity as schools start and stop classes and school days, the components of the school climate monitor 12 may be replicated (e.g., behind load balancing servers) and, in some cases, geographically distributed, e.g., in each time zone of North America. Further, data structures in the school climate monitor 12 may be replicated in multiple hash tables with key values corresponding to different terms for which queries are frequently submitted, or some embodiments may store records in a relational database or other type of data structure selected to facilitate low-latency access to large volumes of data.

The school climate monitor 12 may, in some embodiments, host a web-based application accessible via web browsers on the user devices 16, or in some embodiments, the school climate monitor 12 may host an application program interface (API) by which native applications on the user devices offer the functionality described herein. To this end, some embodiments include an input/output module 26, an interface generator 28, a data repository 30, and a controller 31. These components are illustrated as discrete functional blocks, but it should be understood that hardware and software by which such functionality is provided may be different arranged, e.g., sub-divided, replicated, intermingled, conjoined, or the like.

The input/output module 26 may handle session management and network and application layer protocols for the monitor 12. In some cases, the module 26 is a web server, such as a non-blocking webserver operative to support relatively high volumes of web requests. Received web requests may be advanced to, and responsive data may be received from, the controller 31 by module 26. In other cases, the module 26 may be an API server configured to advance API commands to, and receive API responses from, the controller 31.

The interface generator 28, in some embodiments, is operative to generate the interfaces described herein, e.g., by populating web page templates with data retrieved from the data repository 30 by the controller 31 at the instruction of controller 31. In other cases, client-side code (e.g., previously sent JavaScript™ or a native application) may be operative to present interfaces with just the data displayed therein being received at the client, e.g., in response to receiving a serialized data transmission with the data to be displayed from monitor 12, in which case, generating an interface may merely entail retrieving the needed data to effect such client-side operations.

The data repository 30 may store the data obtained relating to school climate as well as data needed to organize and allow the appropriate access to that data. In some cases, the data repository 30 may be a relational database, or some embodiments may use document objects or other techniques for storing a plurality of key-value pairs of data associations described herein. In the illustrated example, the data repository 30 includes a student record repository 38 (to store a profile of each student including log-in credentials, demographic data, survey responses, and mappings to records for classes, campuses, and districts the student attends), a survey definition repository 36 (to store one or more surveys, as well as rules for dynamically generating surveys in some cases, and corresponding content for presenting candidate answers to survey questions), a roles and permission repository 34 (to store records defining access at each district and campus for the various faculty roles), and an organizational repository 32 (to store faculty profiles with log-in credentials, as well as mappings of faculty to class period, campus, and district).

The controller 31 may direct the activities of the other components of the school climate monitor 12. For instance, when (e.g., in response to) a web request for a dashboard is received, the controller 31 may instruct the interface generator 28 to generate a responsive dashboard; the interface generator 28 may retrieve a template for the dashboard from memory; and request that the controller 31 instruct the repository 30 to retrieve values for populating the template. Then the controller 31, in some embodiments, may direct the input/output module 26 to send the dashboard interface to a user device 16 for presentation.

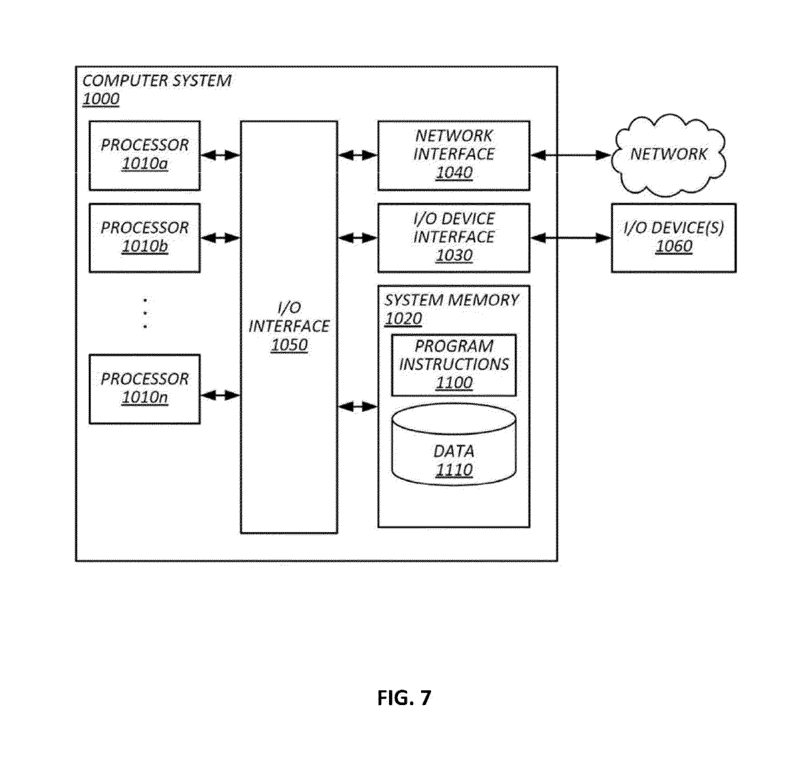

The user devices 16 may be any of a variety of computing devices, examples of which are described below with reference to FIG. 7. In some cases, the users devices are smart phones of students and teachers, or in some cases, the user devices 16 are other types of portable computing devices, like a set of tablet computers or laptops the students pass around before class to complete surveys and register their attendance. Given student experiences with social media on smartphones and norms favoring openness and sharing, it is believed that students will be substantially more forthcoming in the context of a touch-enabled user device, relative to written paper interfaces that students commonly associate with school work and testing.

In some cases, each user device 16 in a school or a classroom may route exchanges through a router, such as a WiFi router provided in a school local area network. As a result, some embodiments may use a relatively well-defined and limited set of Internet Protocol (IP) addresses that may be used in a whitelist for security purposes, as explained further below.

FIG. 1B shows an example flow chart of a process for using the computing environment 10 of FIG. 1A. In some embodiments, the application hosted by the school climate monitor 12 is referred to by the trade name of “edMosphere”™. Requests and responses indicated in the flow chart may pass through, and be effected by, the school climate monitor 12, with corresponding interfaces being presented on the user devices 16.

Embodiments include a computer-based school climate measurement and management tool that captures how students experience school in real-time and reports that information to teachers and school administrators in real-time, positioning them to be proactive rather than reactive. To this end and others, embodiments are designed with the following in mind:
a. school climate is dynamic and can change from day;
b. accurate information allows teachers and administrators to operate more effectively and efficiently;
c. what a student presents outwardly is often not the same as what the student experiences inwardly;
d. teachers operate within a limited timeframe;
e. positive school climate is related to increased student engagement, increased academic outcomes and increased teacher retention.

Embodiments may gather information about school climate with one or more student surveys. Student participation, in some implementations, is not anonymous and is designed to be mandatory, however students can skip questions once they have logged into the survey. To reduce the marginal cost in student and teacher time and effort over existing classroom procedures, some embodiments register that a student is present in the class in response to a student log in, thereby electronically taking attendance. Further, some embodiments provide an application program interface for exporting attendance records to other school systems and provide reports on attendance. Accordingly, applicants expect that the survey will commonly be administered relatively often, e.g., daily, once per period, or weekly, to track attendance and provide near real-time information about school climate.

The survey, in some implementations, is web-based and can be accessed from any device that is web-enabled, e.g., has a web browser and access to the Internet. In some embodiments, the student user logs into the web-based survey with a pre-assigned username and password. Some embodiments may include a special-purpose native application (e.g., an app accessible through a phone maker's platform for obtaining approved apps) may render interfaces and interact with a remote server, rather than (or in addition to) using a web browser.

After (e.g., in response to) logging in, the student may be presented with a series of 10 questions, one question at a time, again to reduce cognitive load for, in some cases, elementary school students. For some types of surveys, each question is grounded in the four major areas within school climate that have been identified by the NSCC: safety, relationships, teaching and learning, and external factors.

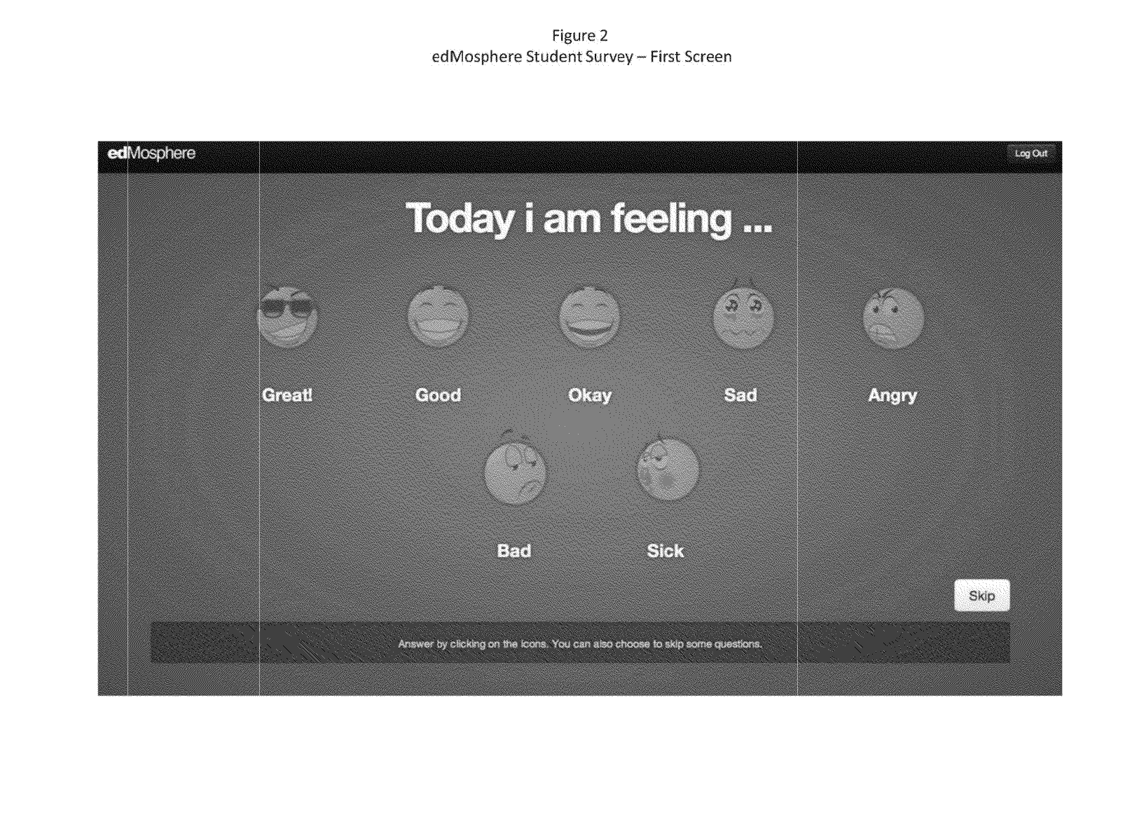

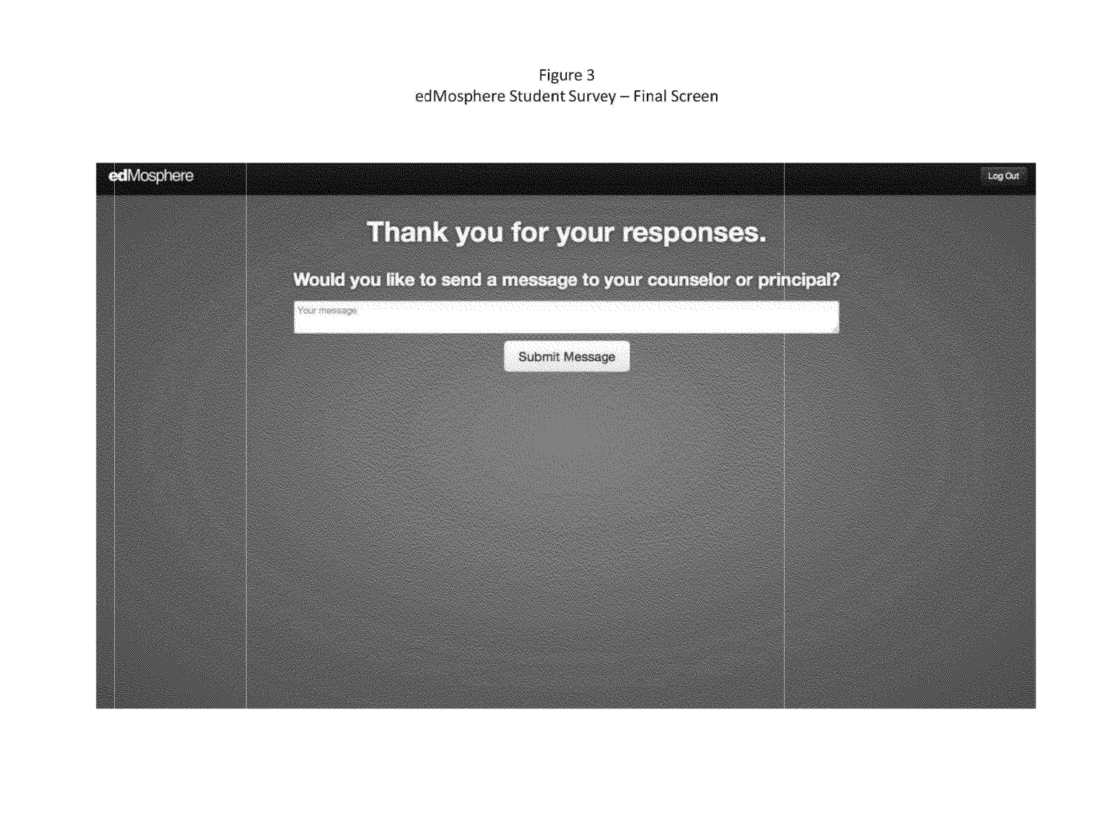

FIGS. 2 and 3 provide screen shots of two questions in an example student survey.

In the example of FIG. 2, a question of “today I am feeling . . . ” is presented, and seven candidate answers are presented, ranging from “Great!” to “Sick.” Each candidate answer in this embodiment includes an image, e.g., one of a number of faces conveying a semantic value of the answer and that is glanceable (thereby lowering cognitive load) and meaningful to students who have difficulty reading (as is often particularly relevant for at-risk, younger elementary school students). The images, in some embodiments, when presented on a user device 16, may be user-selectable and associated with an event handler that, when triggered by a user selection (e.g., an on-click event or on-touch event of the corresponding image), causes a value indicative of the selection to be sent from the user device 16 to the school climate monitor 12 to register the response in a corresponding student record.

In some cases, students may log-in on the user device, using a log-in interface from the monitor 12, and a value indicative of the student's identity may be maintained server-side or client-side (e.g., in a cookie or LocalStorage object) and exchanged to the extent needed to associate responses with a student record.) The controller 31 may verify log-in credentials against values in the student records in repository 38. In some cases, a script specifying the event handlers is sent with the interface by the school climate monitor 12 to the client device 16.

In the example of FIG. 3, a text input above the “submit message” button is provided in a question interface presented on a student user device 16. Entered text may be transmitted to the school climate monitor 12 in response to a student selecting the “submit message” button using techniques like those described above relating to event handlers and session tracking to associate responses with student records in memory of the school climate monitor 12.

In some embodiments, student-submitted text is searched for keywords in response to a submission by the controller 31 of FIG. 31. The controller 31 may store in memory a hierarchical taxonomy of school-climate related issues, e.g., safety→bullying→in-school bullying, and each node of the taxonomy may be associated with one or more keywords (e.g., and common misspellings, like terms within a threshold edit distance of a keyword, such as within one or two characters). In response to detecting a keyword (including such misspellings), some embodiments may include a description of the issue in graphical association with the student when generating a dashboard for a teacher or administrator, so that action can be taken promptly. Some embodiments may further provide interfaces associated with the description of the issue for launching a workflow to deal with the issue, such as a button that when selected by a teacher sends an email to an administrator with a description of the issue and an identifier of the student.

In some cases, each node may be associated with a plurality of n-grams (e.g., sequences of two or more words, like two, three, or four, depending on computational power and memory available), and each n-gram may be associated with a weight (e.g., 0 to 1, with 1 having higher weight) indicative of the likelihood that the n-gram is indicative of the corresponding issue of the associated node. For instance, the node “depressed” may be associated with an n-gram “feel bad” having a weight of 0.7 and an n-gram of “very sad” having a weight of 0.9. Embodiments may search submitted text for n-grams and calculate an aggregate score, e.g., a sum of the weights of found n-grams, in some cases normalized by the size of the text (e.g., by dividing the score by the number of words submitted) to calculate a score for each issue connoted by each node. Nodes having a score greater than a threshold may, in response, be reported on one or more of the various dashboard interfaces by monitor 12. In some cases, each node of the taxonomy may also be associated with a seriousness index that is multiplied by, or added to, the aggregate score, so that, for example, issues relating to safety may be surfaced on a dashboard more frequently.

In some cases, the number of questions is relatively small to reduce the amount of student effort consumed, as it is expected that the survey will be administered frequently in some use cases. For instance, for elementary school users, less than 15 questions, e.g., ten or fewer or five or fewer, questions may be presented in a given survey session (e.g., on a given day). To reduce the number of questions, while maintaining a broad scope of coverage, some embodiments may dynamically generate surveys, e.g., randomly selecting among a larger pool of survey questions, cycling through a set of surveys, or using skip logic to select subsequent questions based on responses to previous questions. In some cases, embodiments dynamically generate surveys based on a student profile, e.g., a history of reported bullying may cause survey questions related to this topic to be up-weighted in a ranking algorithm executed by controller 31, or a student profile indicating that the student receives subsidized lunches may cause embodiments to up-weight questions relating to whether the student is hungry.

To further reduce cognitive load, relatively few candidate answers are associated with each question in some embodiments. In an example survey for elementary school children, nine of the ten questions provide two to seven student-selectable candidate answer choices, depending on the question. Each question may include a skip button, which allows the student to skip the question if they so choose.

After (or while) the student completes the survey, in some use cases, their answers are aggregated by some embodiments. In some embodiments, each student selection of a candidate answer may cause a student user device to report (e.g., with an on-touch, or on-click event handlers executed by a student user device and associated with each respective candidate answer) that answer to a remote server at which answers are aggregated, organized, analyzed, and stored, e.g., with a hyper-text transfer protocol (HTTP) post command, or by accessing a corresponding application program interface of the server with a native application (which is not to suggest these designs are mutually exclusive, as some apps may use HTTP exchanges).

Upon analyzing the reported answers, some embodiments of the application generate a numeric measurement of school climate indicators. The numeric value (or other data to be surfaced) may be graphically displayed on a teacher dashboard interface of on a teacher user device, a campus dashboard on an administrator user device, or (i.e., and/or) a district dashboard interface on an administrator user device, such that the teacher/administrator can gauge school climate in real-time, in contrast to many conventional techniques that measure school climate much less frequency and yield an analysis often several days or weeks after measurement.

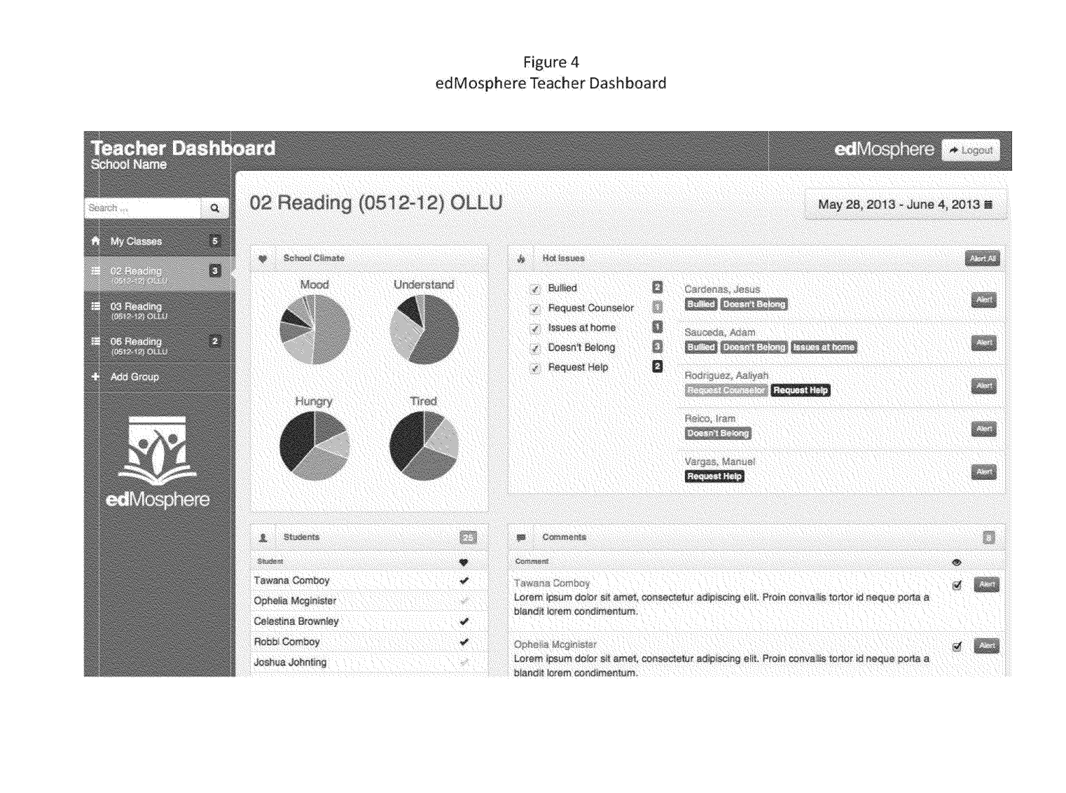

As shown in FIG. 4, the teacher dashboard interface of this example contains aggregated student answers to a survey, organized by period. The dashboard may include four main components in some implementations that are reflected in the graphical arrangement (e.g., in spatial layout or styling): the school climate snapshot (at the class period level); a class hot issues listing (e.g., certain candidate answers to questions or keywords in text answers may trigger at the server a designation of the answer as a hot issue); a list of student respondents; and a list of all text that students submitted. The dashboard, in some cases, allows teachers to toggle between their various class periods and between a range of dates. In some cases, teacher-selectable buttons on the dashboard interface may request an updated interface responsive to the requested view, and the remote server may query and return the corresponding data. The hot issues box and the alert buttons are examples of “school climate management” features. The alert buttons may allow the teacher to quickly (e.g., with a single button press) alert pre-designated stakeholders (e.g., the school counselor, principal, parent, etc) about information that a student reported in the system, e.g., via email, short message service (SMS) text messages, or by adding the issue to a workflow queue of the administrator in the system. The dashboard, in some cases, allows teachers to access individual responses to the survey as well.

In this example, the campus dashboard contains aggregated student answers to the example edMosphere survey, organized by teacher. The dashboard includes two main components: the school climate snapshot (at the campus level) and campus hot issues listing (currently defaulted to bullying). The dashboard allows administrators to toggle between various teachers on the school campus and between a range of dates. The dashboard may allow administrator to access the teacher dashboard interface for each teacher who uses present system on the campus based on records stored in the roles and permissions repository 34.

In some embodiments, the teacher dashboard also includes links to professional development content selected by the controller 31 of FIG. 1A. In some cases, a hierarchical taxonomy of issues related to school climate are stored in memory of the monitor 12, and each node of the taxonomy may be associated with one or more content items (e.g., a video in which another teacher explains techniques they have used to address the issue, an academic article related to the issue, or classroom materials like handouts to use when addressing the issue). In response to detecting such an issue, e.g., in response to student entered text, a student answer to a question, a pattern of student answers to questions (like more than a threshold amount—frequency or number—of students giving an answer over a trailing duration), embodiments may identify and include such content in the teacher dashboard.

In some cases, embodiments track whether a teacher engages (e.g., views, self-reports, or demonstrates mastery in response to follow-up questions) of the professional development material, and records of such engagement may be stored in teacher records of the monitor 12 to track and report on professional development training requirements for teachers.

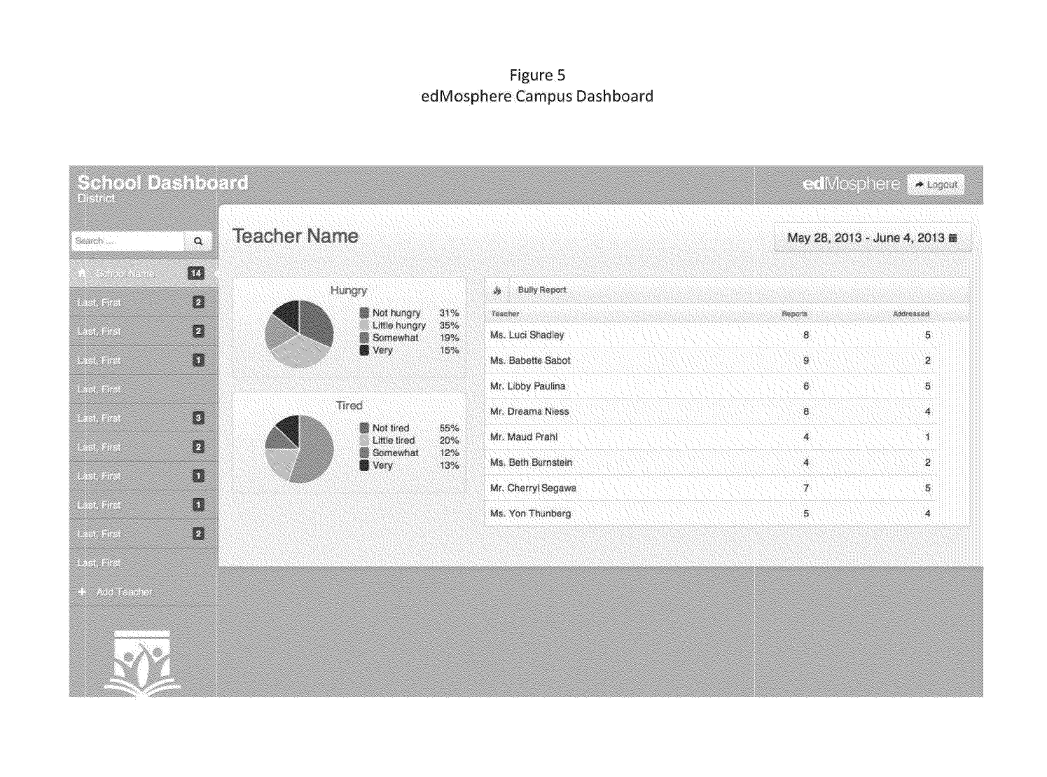

FIG. 5 shows an example of a campus dashboard interface, which may contain aggregated student answers to the example survey, organized by teacher. The campus dashboard may include displays of pie charts showing aggregated student responses to selected survey questions. In some embodiments, the dashboard also shows a listing of hot issues, in this case relating to bullying. Some embodiments further allow (e.g., with administrator-selectable buttons, associated event handlers, and data exchanges like those described above with respect to the teacher dashboard interface) an administrator to view teacher dashboards for teachers on the campus.

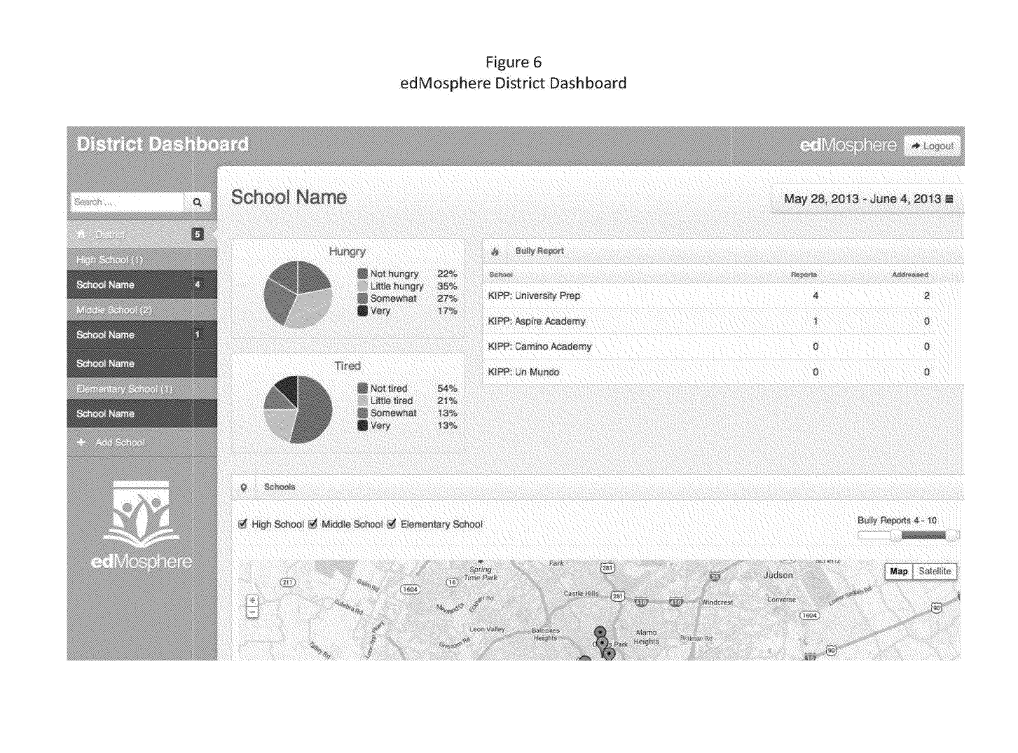

FIG. 6 shows an example of a district dashboard interface, which may contain aggregated (in the same or a similar fashion to that described above) student answers to the survey, organized by school campus. The dashboard may include two components in some designs: the school climate snapshot (at the district level), and a district hot issues listing (currently defaulted to bullying). The dashboard, in some embodiments, allows administrators to toggle between various campuses within the district and between a range of dates (e.g., with administrator-selectable buttons, associated event handlers, and data exchanges like those described above with respect to the teacher dashboard interface). The dashboard may allow (e.g., in this context, provide interfaces programmed to effect) administrators to access the campus dashboard for each campus in the district that uses the system and the teacher dashboard for each teacher who uses the system on each campus in the district.

It should be noted that references to “the invention” in the parent provisional application are not intended to define the scope of patent rights. These references are shorthand for embodiments of the inventive concepts disclosed therein and, as such, should not be read as being inconsistent with, or further limiting, the presently filed claims. Rather, references to “the invention” should be construed as references to an embodiment of the invention.

While the term “school climate,” and similar terms do not have a single definition, as noted in the parent provisional application, for purposes of this document, the definition noted in the parent provisional filing will be used, i.e., “as the quality and character of school life.” Examples of factors affecting school climate include whether students feel safe, are being bullied, are well fed, are well rested, and the like.

Real-time measurement of school climate is important because issues that affect school climate are often transient, short lasting events that are best addressed at the time the issue arises. Generally, real-time measurement of school climate provides a teacher or administrator with information relevant to an issue affecting school climate for a student on the day that issue is affecting the student and, in some cases, during a class period in which the student is surveyed regarding their perception of school climate, e.g., in programs in which students attend multiple periods throughout the day and attend classes with multiple teachers. When information is gathered “during a class period,” this encompasses the period between classes and before classes start, e.g., while students are in a classroom waiting for class to start.

In some cases statistics and student issues relating to school climate are presented with a dashboard interface. Generally, school faculty operate with a high cognitive load when working with students, so a dashboard interface that surfaces relevant issues with relatively little, to no interaction by faculty is expected to make the present techniques more useful in schools. Generally, such dashboard interfaces present an overview of a given set of students (e.g., a class period, a grade, a school, a district, a demographic group, a psychodemographic group, or the like). Dashboards generally present one or more aggregate statistics characterizing group statistics (e.g., the percentage of students who feel bullied) and one or more student-specific issues of particular concern, e.g., a list of students reporting that they came to school hungry or not well rested. Dashboards generally update automatically, e.g., with periodic refreshes, or by pushing updated information, e.g., with a full duplex websocket connection. Or in some cases, dashboards are updated with relatively little user interaction, e.g., selecting a single refresh button, to avoid burdening the user.

Dashboards are said to be generated and sent for presentation on user devices. Generating a dashboard generally includes obtaining the information to be presented and formatting the information such that a user device is responsive to the information to present or update the dashboard, e.g., generating a dashboard may include obtaining structured data, like serialized data formats, such as extensible markup language (XML) or JavaScript™ object notation (JSON), to be sent to a native mobile application for display, or generating a dashboard may entail composing JavaScript™, cascading style sheets (CSS), and hypertext markup language (HTML) that includes the information and, when rendered, displays the dashboard in a web browser of a user device.

A dashboard is one type of interface described herein. Other types include log-in interfaces and interfaces for presenting questions to students. Interfaces are generally data (which may include commands) that when sent to a user device, cause the user device to display information and, in some cases, receive user inputs and return data indicative of those inputs, e.g., commands from the user to present a different interface or respond with an answer to a question. Like the dashboard interface, interfaces generally may be data in a format that, when received by a native application, causes the native application to present the interface, or the interface may include a webpage for display in a browser. Interfaces, in some cases, are sent through a series of exchanges between a server and a client, in some cases, following user interaction with part of the interface that has already been sent.

In some cases, when the dashboard surfaces (e.g., displays with a relatively high visual weight) an issue faced by a student or class period, some embodiments may present professional development content relating to the issue, e.g., a video lecture by another teacher explaining techniques they have used to address bullying, or written material to explain the how the teacher might best deal with a student coming to class hungry. The content may be video, text, audio, or in other formats, e.g., interactive question and answer test that are automatically evaluated to diagnose where the teacher might need help. In some cases, content is provided by sending hyperlink (or other instructions for accessing content) to a third part video or content hosting service.

It should be noted that when it is said content is sent, provided, or the like, to a client device, such discussion encompasses use of (e.g., sending links for) content delivery networks that host content geographically closer to users to reduce latency.

Another technique for reducing the cognitive load on students is the use of images (e.g., photos, icons, video, or animated GIFs) to convey the semantic value of answers to questions. For instance, a student-selectable answer to a question in a question interface may include a happy face icon that has a sematic value of “happy,” or “no problem with a particular aspect of school climate.” Or a sad-faced image may have a sematic value of “sad” or “I'm suffering from the issue targeted by the present question.”

A variety of types of user devices are described herein. In some cases, the user devices are mobile user devices (e.g., cell phones or tablet computers) having a portable power supply and wireless network access (e.g., a cellular connection or a wireless local area network connection) to the Internet. Embodiments are consistent with other types of users devices, though, including kiosk computers in classrooms, desktop computers, laptop computers, and the like. To reduce the cognitive load on teachers and students, some embodiments may employ user devices with touchscreens interfaces. Such interfaces, it is believed, tend to be inviting to students accustomed to extensive sharing on cell phones, leading students to be more forthcoming when revealing their perception of school climate.

When obtaining potentially sensitive information relating to school climate from students, generally it is important that the application be secure to protect student privacy and the integrity of data obtained. A number of techniques may be used to enhance security. In some cases, a URL schema may be obfuscated to make it difficult for students to guess what URL will yield information about a fellow student, e.g., by not using a student name or a relatively short student identifier in a URL. For example, a relatively long, like 32 or 64 character hash value may be calculated based on student identifiers (like name and social security number) to obfuscate the URL schema. To protect against brute force attacks, some embodiments may rate limit client request (e.g., log in requests) by determining whether a client device has submitted more than a threshold amount of such request in a trailing duration of time and, in response to exceeding threshold amount (like a count or frequency), blocking further attempts for some period of time (like 24 hours). To protect against third party attacks, some embodiments may take advantage of the relatively confined network address space of school networks and whitelist IP addresses of client devices to which the system is responsive, blocking access by devices off the whitelist, and providing an administrator accessible datastore for updating the whitelist as new schools are added and provide the range of IP addresses at that school. Further, to protect against man-in-the-middle attacks, some embodiments may encrypt communications between servers and clients, e.g., with the TLS encryption scheme.

FIG. 7 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

To mitigate the problems described herein, the applicants had to both invent solutions and, in some cases just as importantly, recognize problems overlooked (or not yet foreseen) by others in the field. Indeed, applicants wish to emphasize the difficulty of recognizing those problems that are nascent and will become much more apparent in the future should trends in industry continue as applicants expect. Further, because multiple problems are addressed, it should be understood that some embodiments are problem-specific, and not all embodiments address every problem with traditional systems described herein or provide every benefit described herein. That said, solutions to many of these problems are described above.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

What is claimed is:

1. A method of surveying students to assess school climate and, based on survey answers, providing a real-time dashboard showing school climate to teachers, such that a troubled student's problems can be addressed before the troubled student's education is impaired, the method comprising:
obtaining a student identifier of a student and a class period identifier of a class period in which the student is enrolled;
during the class period, sending, over a network to a student user device of the student, one or more interfaces to present a plurality of questions to the student on the student user device, the plurality of questions relating to the student's perception of school climate;
receiving, over the network, from the student user device, answers to at least some of the plurality of questions;
storing, in memory, the answers in association with the student identifier and the class period identifier;
generating, with one or more processors, a teacher dashboard interface based on the stored answers from the student and answers from other students in the class period to at least some of the plurality of questions; and
sending, over the network, to the teacher user device, the teacher dashboard interface, wherein the dashboard interface is updated in real-time to reflect the answers from the student and the answers from other students in the class period, such that a teacher is presented the opportunity to address problems with the school climate during a given instance of the class period in which the plurality of questions are presented to the student.

2. The method of claim 1, wherein the one or more interfaces to present a plurality of questions comprise:
a plurality of student-selectable images each associated with one candidate answer to one of the plurality of questions,
each respective question being associated with a plurality of candidate answers, and
each student-selectable image being indicative of a semantic value of the associated candidate answer, such that the student need not read to understand the respective semantic values of the candidate answers; and
instructions to the student user device to send, over the network, to at least some of the one or more processors, in response to the student selecting one of the plurality of student-selectable images, the following:
an indication of which student-selectable image a student selected to provide an answer to a respective one of the plurality of questions; and
a request for another of the one or more interfaces to present a plurality of questions to the student, wherein one question among the plurality of questions is presented to the student at a time.

3. The method of claim 1, wherein generating, with one or more processors, a teacher dashboard interface based on the answers from the student and from answers from other students in the class comprises:
calculating statistics on student responses, the statistics including an amount of students answering a given question with a subset of candidate answers to that question;
determining graphical attributes of visual representations of at least some of the students in the teacher dashboard interface based on the answers from the student and the answers from other students in the class.

4. The method of claim 1, comprising:
generating a district dashboard interface based on answers from students in a plurality of classes in a plurality of schools;
sending the district dashboard interface to a district administrator user device over the network;
generating a campus dashboard interface based on answers from students in a plurality of classes in a given one of the plurality of schools; and
sending the campus dashboard interface to a campus administrator user device over the network.

5. The method of claim 1, wherein the one or more interfaces to present a plurality of questions to the student comprise a text input configured to receive a written answer from the student, the method comprising:
searching text input by the student for keywords indicative of problems with school climate; and
in response to detecting one of the keywords, including an indication of the problem with school climate on the dashboard in association with an identifier of the student.

6. The method of claim 5, wherein searching text for keywords includes calculating an n-gram score for the text, wherein the n-gram score is based on the likelihood that two or more words in sequence are indicative of the problem with school climate, and wherein the keywords include misspellings of words indicative of the problem with school climate.

7. The method of claim 1, comprising:
based on the answers from the student and the answers from other students in the class period, selecting one or more items of professional development content for presentation to the teacher;
sending, over the network, to the teacher user device instructions to access the one or more items of professional development content.

8. The method of claim 7, comprising:
determining whether the teacher engaged with the professional development content; and
updating a teacher record associated with the teacher to reflect that the teacher engaged with the professional development content.

9. The method of claim 1, wherein the teacher dashboard interface comprises a teacher-selectable input to send an email to a school administrator,
the teacher-selectable input being associated with a given answer among the answers from the student and the answers from other students in the class, and
wherein the teacher-selectable input causes an email to be sent to a school administrator, the email including context indicative of the given answer.

10. The method of claim 1, wherein:
obtaining a student identifier comprises:
receiving, over the network, a request for a log-in interface;
sending, to the student user device, the log-in interface by which the student authenticates their identity, wherein the log-in interface is programmed to call instructions that determine an obfuscated uniform resource locator (URL) based on the information entered by the student and send the URL to the server, the obfuscated URL impeding efforts by other students to access profiles of other students by inferring part of a URL schema; and
receiving, over the network, from the student user device, student answers to at least some of the plurality of questions comprises:
receiving answers encrypted with the student user device for transmission over the network.

11. A system, comprising:
one or more processors; and
memory storing instructions that when executed by at least some of the one or more processors causes operations comprising:
obtaining a student identifier of a student and a class period identifier of a class period in which the student is enrolled;
during the class period, sending, over a network to a student user device of the student, one or more interfaces to present a plurality of questions to the student on the student user device, the plurality of questions relating to the student's perception of school climate;
receiving, over the network, from the student user device, answers to at least some of the plurality of questions;
storing, in memory, the answers in association with the student identifier and the class period identifier;
generating, with one or more processors, a teacher dashboard interface based on the stored answers from the student and answers from other students in the class period to at least some of the plurality of questions; and
sending, over the network, to the teacher user device, the teacher dashboard interface, wherein the dashboard interface is updated in real-time to reflect the answers from the student and the answers from other students in the class period, such that a teacher is presented the opportunity to address problems with the school climate during a given instance of the class period in which the plurality of questions are presented to the student.

12. The system of claim 11, wherein the one or more interfaces to present a plurality of questions comprise:
a plurality of student-selectable images each associated with one candidate answer to one of the plurality of questions,
each respective question being associated with a plurality of candidate answers, and
each student-selectable image being indicative of a semantic value of the associated candidate answer, such that the student need not read to understand the respective semantic values of the candidate answers; and
instructions to the student user device to send, over the network, to at least some of the one or more processors, in response to the student selecting one of the plurality of student-selectable images, the following:
an indication of which student-selectable image a student selected to provide an answer to a respective one of the plurality of questions; and
a request for another of the one or more interfaces to present a plurality of questions to the student, wherein one question among the plurality of questions is presented to the student at a time.

13. The system of claim 11, wherein generating, with one or more processors, a teacher dashboard interface based on the answers from the student and from answers from other students in the class comprises:
calculating statistics on student responses, the statistics including an amount of students answering a given question with a subset of candidate answers to that question;
determining graphical attributes of visual representations of at least some of the students in the teacher dashboard interface based on the answers from the student and the answers from other students in the class.

14. The system of claim 11, comprising:
generating a district dashboard interface based on answers from students in a plurality of classes in a plurality of schools;
sending the district dashboard interface to a district administrator user device over the network;
generating a campus dashboard interface based on answers from students in a plurality of classes in a given one of the plurality of schools; and
sending the campus dashboard interface to a campus administrator user device over the network.

15. The system of claim 11, wherein the one or more interfaces to present a plurality of questions to the student comprise a text input configured to receive a written answer from the student, the operations comprising:
searching text input by the student for keywords indicative of problems with school climate; and
in response to detecting one of the keywords, including an indication of the problem with school climate on the dashboard in association with an identifier of the student.

16. The system of claim 15, wherein searching text for keywords includes calculating an n-gram score for the text, wherein the n-gram score is based on the likelihood that two or more words in sequence are indicative of the problem with school climate, and wherein the keywords include misspellings of words indicative of the problem with school climate.

17. The system of claim 11, comprising:
based on the answers from the student and the answers from other students in the class period, selecting one or more items of professional development content for presentation to the teacher;
sending, over the network, to the teacher user device instructions to access the one or more items of professional development content.

18. The system of claim 17, comprising:
determining whether the teacher engaged with the professional development content; and
updating a teacher record associated with the teacher to reflect that the teacher engaged with the professional development content.
#[Workflow Related Features]

19. The system of claim 11, wherein the teacher dashboard interface comprises a teacher-selectable input to send an email to a school administrator,
the teacher-selectable input being associated with a given answer among the answers from the student and the answers from other students in the class, and
wherein the teacher-selectable input causes an email to be sent to a school administrator, the email including context indicative of the given answer.
#[Security Related Features]

20. The system of claim 11, wherein:
obtaining a student identifier comprises:
receiving, over the network, a request for a log-in interface;
determining whether a request for a log-in interface is received from an IP address on a whitelist of IP addresses associated with a school;
sending, to the student user device, the log-in interface by which the student authenticates their identity, wherein the log-in interface is programmed to call instructions that determine an obfuscated uniform resource locator (URL) based on the information entered by the student and send the URL to the server, the obfuscated URL impeding efforts by other students to access profiles of other students by inferring part of a URL schema;
determining whether the student user device has submitted more than a threshold amount of log-in requests in a trailing duration of time to rate limit attempts to guess passwords; and
receiving, over the network, from the student user device, student answers to at least some of the plurality of questions comprises:
receiving answers encrypted with the student user device for transmission over the network.
